(19) United States
(12) Patent Application Publication
(10) Pub. No.: US 2009/0239103 A1
(43) Pub. Date: Sep. 24, 2009

(54) POLYMER THIN-FILM, PROCESS FOR PRODUCING PATTERNED SUBSTRATE, MATTER WITH PATTERN TRANSFERRED, AND PATTERNING MEDIUM FOR MAGNETIC RECORDING

(76) Inventors: Hirokazu Hasegawa, Kyoto (JP); Mikihito Takenaka, Kyoto (JP); Hiroshi Yoshida, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/094,218

(22) PCT Filed: Nov. 17, 2006
(86) PCT No.: PCT/JP2006/323018

§ 371 Date: May 19, 2008

(30) Foreign Application Priority Data
Nov. 18, 2005 (JP) 2005-334979

(51) Int. Cl. C08L 101/00; C08J 5/18; C08L 53/00; G11B 5/73; B32B 3/10

(52) U.S. Cl. 428/847.1; 428/138; 427/246; 428/131; 427/256; 427/271; 427/265; 427/264; 428/195.1

(57) ABSTRACT

A polymer thin film 30 includes a continuous phase 10 primarily composed of polymers of a first monomer 11 and cylindrical microdomains each of which is primarily composed of a polymer of a second monomer 21, the cylindrical microdomains 20 being distributed in the continuous phase 10 and oriented along the penetration direction through the film, wherein the polymer thin film 30 contains block copolymers 31 which include at least respective first segments 12 formed by polymerization of the first monomer 11 and respective second segments 22 formed by polymerization of the second monomer 21, and polymers 13 compatible with the first segments.

### TECHNICAL FIELD

The present invention relates to a polymer thin film having a microphase separated structure in which cylindrical microdomains are oriented along the penetration direction through the film. Further, the invention relates to a method of producing a patterned substrate having on the surface thereof a regular array pattern of this microphase separated structure. Still further, the invention relates to a pattern carrier for transfer of the regular array pattern onto an object (a transfer object) and relates to a patterned medium for magnetic recording produced using this pattern carrier.

### BACKGROUND ART

In recent years, with miniaturization and high performance of electronic devices, energy storage devices, sensors and the like, necessity of forming a regular array pattern, which is fine in a size of nanometers to hundred nanometers, on a substrate has been risen. Therefore, it is required to establish a process capable of producing a structure with such a fine pattern in high precision and low cost.

As a processing method of such a fine pattern, a top-down method represented by lithography, that is, a method providing a shape by finely engraving a bulk material is generally used. A representative example is photolithography used for fine processing of semiconductors, such as producing LSIs.

However, as the degree of fineness of a fine pattern rises, applying such a top-down method increases difficulty both in the device and process. Particularly, when the processing dimensions of a fine pattern are as fine as several dozen nanometers, it is necessary to use an electron beam or deep UV rays for patterning, which requires a huge investment for equipment. Further, when it is difficult to form a fine pattern applying a mask, it is forced to apply a direct drawing method, where the problem of a significant drop in processing through put cannot be avoided.

In such a situation, attention is paid to a process applying the phenomenon of self assembly of a structure of a substance, in other words, self assembly phenomenon. Particularly, a process applying the self assembly phenomenon of block copolymers, so-called microphase separation, is an excellent process in that the process is capable of forming a fine regular structure having various shapes in a size ranging from several dozen nanometers to several hundred nanometers by a simple coating process.

Herein, when polymer segments of different kinds of block copolymers do not mix with each other (incompatible), a fine structure having a specific regularity is self assembled by phase separation (microphase separation) of these polymer segments.

As an example of forming a fine regular structure, using such a self assembly phenomenon, there is known a technology for forming a structure, such as holes, or lines and spaces, on a substrate, using as an etching mask a block copolymer thin film composed of a combination of polystyrene and polybutadiene, polystyrene and polyisoprene, polystyrene and polymethylmethacrylate, or the like (for example, refer to the later described Non-patent Document 1 and Non-patent Document 2).

Incidentally, by the microphase separation phenomenon of block copolymers, it is possible to obtain a polymer thin film having a structure with a regular array of spherical or cylindrical microdomains in a continuous phase.

When using such a microphase separated structure as a pattern carrier, such as an etching mask, it is desirable that cylindrical microdomains are regularly arranged such as to be oriented along the direction (penetration direction through a film) perpendicular to a substrate.

It is because, in a structure where cylindrical microdomains are perpendicular to the substrate, the aspect ratio (the ratio of the domain size along the direction perpendicular to the substrate, to the domain size along the direction parallel to the substrate) of an obtained structure can be adjusted more freely, compared with a structure where spherical microdomains are regularly arrayed on the surface of a substrate.

On the other hand, when using a microphase separated structure having spherical microdomains as a pattern carrier, such as an etching mask, the maximum aspect ratio of an obtained structure is 1, and accordingly, the aspect ratio is smaller and lacks the degree of freedom for adjustment, compared with the case of cylindrical microdomains perpendicular to a substrate.

However, in a cylindrical microdomain structure formed by the microphase separation phenomenon of block copolymers, cylindrical microdomains are often oriented parallel to the surface of the film.

Conventional methods for orienting cylindrical microdomains, which tend to be oriented parallel to the surface of a film, along the direction (penetration direction through the film) perpendicular to a substrate includes the followings.

In a first conventional method, an extremely high electric field is applied to a film of block copolymers in the penetration direction through the film so as to orient cylindrical microdomains along the direction of the electric field, thereby obtaining a structure in which the cylindrical microdomains are perpendicular to the surface of the film (for example, refer to Non-patent document 3).

In a second conventional method, the surface of a substrate is chemically modified so as to make respective segments of block copolymers have the same affinity, thereby obtaining a structure in which the cylindrical microdomains are perpendicular to the surface of the substrate (for example, refer to Non-patent document 4).

Non-patent Document 1: Science 276 (1997)1401

Non-patent Document 2: Polymer 44 (2003) 6725

Non-patent Document 3: Macromolecules 24 (1991) 6546

Non-patent Document 4: Macromolecules 32 (1999) 5299

However, in the above described first conventional method, in order to apply a high electric field to the film of block copolymers, a special process or equipment has been necessary, such as the necessity of applying a voltage to the film between an extremely narrow gap formed by a tight contact of an electrode with the surface of the film.

Further, in the above described second conventional method, it has not been easy, in general, to make the respective segments of block copolymers on the surface of a substrate have the same affinity.

As a problem due to these points, it has been impractical to make cylindrical microdomains perpendicular to the surface of a film, employing these conventional methods.

As has been described above, although a method of obtaining a regular structure as fine as in the range from several dozen nanometers to several hundred nanometers applying the microphase separation phenomenon of block copolymers is simple and low in cost, it has been difficult to orient cylindrical microdomains along the penetration direction through a film.

### DISCLOSURE OF THE INVENTION

Addressing problems as described above, the invention provides a polymer thin film having a regular array pattern with cylindrical microdomains oriented along the penetration direction through the film, using the microphase separation phenomenon of block copolymers. Further, the invention provides a method of producing a patterned substrate having this regular array pattern on the surface. Still further, the invention provides a pattern carrier, such as an etching mask, capable of providing a fine and regular array pattern having a large aspect ratio onto the surface of an object (a transfer object, namely an object to which a pattern is transferred), and a patterned medium for magnetic recording.

To solve the above described problems, in an aspect of the invention, there is provided a polymer thin film, including:

a continuous phase primarily composed of polymers of a first monomer; and

cylindrical microdomains each of which is primarily composed of a polymer of a second monomer, the cylindrical microdomains being distributed in the continuous phase and oriented along a penetration direction through the film,

wherein the polymer thin film contains block copolymers which include at least respective first segments formed by polymerization of the first monomer and respective second segments formed by polymerization of the second monomer, and polymers compatible with the first segments.

In this aspect of the invention, cylindrical microdomains, which tend to be oriented parallel to a film, are oriented along the penetration direction through the film due to the action of polymers.

According to the invention, using the microphase separation phenomenon of block copolymers, it is possible to provide a polymer thin film having a regular array pattern with cylindrical microdomains oriented along the penetration direction through a film. It is also possible to provide a method of producing a patterned substrate having this regular array pattern on the surface. Further, it is possible to provide a pattern carrier, such as an etching mask, capable of providing a fine and regular array pattern with a large aspect ratio on the surface of an object (the transfer object), and a patterned medium for magnetic recording capable of improving the recording density.

### BRIEF DESCRIPTION OF THE DRAWINGS

In FIG. 1, (a) is a perspective cross-sectional view of a polymer thin film in accordance with an embodiment of the invention, and (b) is a top view of the film;

In FIG. 2, (a) is a conceptual view of a block copolymer being an element constituting a polymer thin film in accordance with the embodiment, (b) is a conceptual view of a polymer, (c) is an enlarged top view of unit structures of the polymer thin film, and (d) is a cross-sectional view taken along line P-P of the unit structures shown in (c);

In FIG. 3, (a) to (d) are conceptual views of types of block copolymers;

In FIG. 4, (a) to (d) are views illustrating changes, of the microphase separated structure of a polymer thin film, which can occur when the volume ratios of the first monomer and the second monomer are changed, and (e) to (g) are views of surface images observed by an atomic force microscope, corresponding to (b) to (d);

FIG. 5 illustrates a process, showing a method of producing a patterned substrate with a polymer thin film in accordance with an embodiment of the invention;

FIG. 6 illustrates a process, showing a method of producing a patterned substrate with a polymer thin film in accordance with an embodiment of the invention;

FIG. 7 illustrates a process, showing a method of producing a patterned substrate with a polymer thin film in accordance with an embodiment of the invention;

FIG. 8 is a table of observation results showing changes in microphase separated structures which occurred when the containing ratio of polymers was changed, wherein PS was adopted for the first segment and PMMA was adopted for the second segment;

FIG. 9 is a table of observation results showing changes in microphase separated structures which occurred when the containing ratio of polymers was changed, wherein PMMA was adopted for the first segment and PS was adopted for the second segment;

FIG. 10 is a table of observation results showing changes of a microphase separated structure which occurred when the containing ratio of polymers was changed, wherein PMMA was adopted for the first segment, PS was adopted for the second segment, and PVME was adopted for the polymers;

In FIG. 11, (a) and (b) are tables showing composition and conditions of plating solutions for producing patterned substrates by plating;

In FIG. 12, (a) is a schematic view of a stamper, and (b) is an enlarged view of the central portion thereof; and

FIG. 13 is a schematic view of a nanoprinting apparatus.

### DESCRIPTION OF REFERENCE SYMBOLS

10 continuous phase
11 first monomer
12 first segment
13 polymer
20 cylindrical microdomain
21 second monomer
22 second segment
23 third monomer
24 third segment
25, 83 fine pore
26 cylindrical structure
30 polymer thin film
31 (31a, 31b, 31c and 31d) block copolymer
35 porous polymer thin film (pattern carrier)
40 and 41 substrate (transfer object)
50 transfer object
61 and 62 patterned substrate (pattern carrier)
63 patterned substrate (patterned medium for magnetic recording)

### Best Mode for Carrying Out the Invention

### (Regarding a Polymer Thin Film)

Embodiments in accordance with the invention will be described below, referring to the drawings.

As shown in (a) of FIG. 1, a polymer thin film 30 in the present embodiment has a microphase separated structure which includes a continuous phase 10 and cylindrical microdomains 20, and is disposed on a surface of a substrate 40.

The microdomains 20 are distributed in the continuous phase 10 and are oriented along the direction (penetration direction through the film) perpendicular to the substrate 40, namely direction z in (a) of FIG. 1. As shown in (b) of FIG. 1, the cylindrical microdomains 20 form a regular array pattern having hexagonal close-packed structures on the horizontal plane (X-Y plane in the figure) of the polymer thin film 30.

Next, referring to FIG. 2, views of units constituting the polymer thin film 30 are schematically enlarged, and the microphase separated structure of the polymer thin film 30 will be described in more details.

As a primary component, the polymer thin film 30 contains a mixture of block copolymers 31 as shown in (a) of FIG. 2 and polymers 13 as shown in (b) of FIG. 2.

Each block copolymer 31 includes a first segment 12 formed by polymerization of a first monomer 11 and a second segment 22 formed by polymerization of a second monomer 21.

Herein, the degree of polymerization of the second segments 22 in the block copolymers 31 is preferably less than the degree of polymerization of the first segments 12.

By adjusting the degrees of polymerization in such a manner, the binding portions between the respective first segments 12 and second segments 22 have a circular shape as shown in (c) of FIG. 2, and block copolymers 31 can be easily arrayed in such a way.

With the bonding portions between the respective first segments 12 and second segments 22 being boundaries, the region of the continuous phase 10 with a primary component of polymers of the first monomer 11 and regions of the cylindrical microdomains 20 with a primary component of a polymer of the second monomer 21 are formed.

The block copolymers 31 may be synthesized by any appropriate method. However, in order to improve the regularity of the microphase separated structure, it is appropriate to employ a synthesizing method by which the distribution of molecular weight becomes as small as possible, for example, a living polymerization method.

In the present embodiment, as an example of block copolymers 31, an A-B type diblock copolymers formed by bonding between the respective one ends of the first segments 12 and the second segments 22, as shown in (a) of FIG. 2, is illustrated. However, a block copolymer used in the present embodiment may be an A-B-A type triblock copolymer 31a, as shown in (a) of FIG. 3. Further, it is also possible to employ an A-B-C type block copolymer 31b which are composed of more than two polymer segments including a third segment 24 formed by polymerization of a third monomer 23, as shown in (b) of FIG. 3. Still further, besides block copolymers of serially bonded segments as described above, star type block copolymers 31c or 31d each of which is formed by bonding between segments at a point, as shown in (c) and (d) of FIG. 3, may be employed.

Yet further, block copolymers 31 applied in the invention are not limited to those shown in FIG. 3, and the third segment may be bonded with the end, of the first segment, on the side opposite to the second segment. Still further, in (a) of FIG. 3, the location of the first segments 12 and 12′ and the location of the second segment 22 may be replaced with each other.

Coming back to FIG. 2, a polymer formed by polymerization of the first monomer 11 is shown in FIG. 2 (b) as an example of polymers 13. However, polymers 13 are not limited to polymers of the first monomer 11 as described above, and any kind of polymers which is compatible with the first segments 12, of the block copolymers 31, forming the continuous phase 10 can be properly employed.

Concretely, polymer molecules applicable to the polymers 13 will be described as examples. Herein, when the first segments 12 are polystyrene, besides that polystyrene is applicable to the polymers 13, it is also possible to employ polymer molecules which are compatible with the first segments 12 (polystyrene), such as polyphenyleneether, polymethyl vinyl ether, polydimethylsiloxane, poly-(-methylstyrene, nitrocellulose and the like.

Further, when the first segments 12 are polymethylmethacrylate, besides that polymethylmethacrylate is applicable to the polymers 13, it is also possible to employ polymer molecules which are compatible with the first segments 12 (polymethylmethacrylate), such as styrene-acrylonitrile copolymer, acrylonitrile butadiene copolymer, vinylidenefluoride-trifluoroethylene copolymer, vinylidenefluoride-tetrafluoroethylene copolymer, vinylidenefluoride-hexafluoroaceton copolymer, vinylphenol/styrene copolymer, vinylidene chloride/ acrylonitrile copolymer, vinylidenefluoride homopolymer and the like.

Herein, the above described polymer molecules may become incompatible, depending on the molecular weight, concentration, and also composition in a case of copolymers. Further, they may become incompatible, depending on the temperature, and accordingly, they are preferably in a compatible state even at a temperature during heat processing.

The degree of polymerization of the polymers 13 is preferably less than that of the first segments of the block copolymers 31.

The contained amount of the polymers 13 is preferably adjusted as follows in relation with the block copolymers 31.

That is, representing the volume ratio of the sum of the volume of the first segments 12 and the volume of the polymers 13 in the polymer thin film 30 by φ%, and the maximum φ% capable of forming cylindrical microdomains 20 by φ max %, it is preferable to satisfy the following Formula (1). This Formula (1) will be explained later in detail, referring to FIGS. 4, 8, 9 and 10.

φmax−7≦φ≦φmax (1)

In such a manner, adjusting the degree of polymerization and contained amount of the polymers 13 has an effect of orienting most of the cylindrical microdomains 20 along the direction (penetration direction through the film) perpendicular to the substrate 40, as shown in (d) of FIG. 2. It is understood that this is because, as shown in (c) of FIG. 2, each of the contained polymers 13 is distributed at the portion of the center of gravity of the respective unit array of cylindrical microdomains 20, and thereby, as shown in (d) of FIG. 2, cylindrical microdomains 20 having started growing from the surface of the substrate 40 grow perpendicular to the surface without lying.

The array of the polymers 13 or the block copolymers 31, shown in (c) and (d) of FIG. 2, shows the concept and should be interpreted not to limit the scope of right of the invention. Further, the monomers shown by circle marks in FIGS. 2 and 3 are conceptually shown for understanding of the outline of the block copolymers 31 and the polymers 13, and it should not be understood that actual polymer chains are structured in such a manner. Especially, regarding the degree of polymerization of the polymer chains, these figures should not be interpreted to limit the scope of right of the invention.

Now, the above described Formula (1) will be explained, referring to FIG. 4.

Herein, (a) to (d) of FIG. 4 are views showing the microphase separated structures which are formed when the volume ratio of polymers of the first monomer 11 (refer to (a) and (b) of FIG. 2) and the volume ratio of polymers of the second monomer 21, both constituting the polymer thin films 30a, 30b, 30c and 30, are changed.

A microphase separated structure, shown in (a) of FIG. 4, can be formed when the volume ratio of the first segments 12 and the volume ratio of the second segments 22 both forming the block copolymers 31, as shown in (a) of FIG. 2, are substantially equal.

In other words, the polymer thin film 30a in (a) of FIG. 4 has a structure formed by alternate arrays of plate shaped polymer phases 10a and 20a with respective primary components of the first segment 12 and the second segment 22.

A microphase separated structure, shown in (b) of FIG. 4, is for a case where polymers 13 already introduced as a conventional art is not contained, and can be formed when the volume ratio of the first segments 12 is larger than in the case of (a) of FIG. 4. A result of observation of a surface by a later described atomic force microscope is shown in (e) of FIG. 4.

In other words, the polymer thin film 30b in (b) of FIG. 4 has a structure in which cylindrical microdomains 20b are distributed in a continuous phase 10b of the first segments 12. The difference of these cylindrical microdomains 20b from cylindrical microdomains 20 (refer to (d) of FIG. 4) in the present embodiment is that the cylindrical microdomains 20b are lying with respect to a substrate 40, in other words, parallel to the substrate 40.

This is because, in the polymer thin film 30b, the cylindrical microdomains 20b tend to be arrayed in such a manner that segments with a higher affinity with the substrate 40 contact the substrate 40 while segments with a higher affinity with the free surface (the surface opposite to the substrate 40) contact the free surface.

A microphase separated structure shown in (c) of FIG. 4 can be formed when the volume ratio of the first segment 12 is larger than in the case of (b) of FIG. 4. A result of observation of a surface by the later described atomic force microscope is shown in (f) of FIG. 4.

In other words, the polymer thin film 30c in (c) of FIG. 4 has a structure in which spherical microdomains 20c are distributed in a continuous phase 10c of the first segment 12.

In such a manner, as shown in (b) and (c) of FIG. 4, when the volume ratio φ % of the first monomer 11 is continuously increased, the volume ratio has a threshold at which the polymer thin film 30b is switched to the polymer thin film 30c. For Formula (1), this threshold is defined to be the maximum volume ratio φmax capable of forming cylindrical microdomains 20.

Diagram (d) of FIG. 4 is a schematic view showing a polymer thin film 30 (corresponding to (a) of FIG. 1) in the present embodiment, for comparison with the cases of the other diagrams (a) to (c) of FIG. 4. A result of observing a surface by the later described atomic force microscope is shown in (g) of FIG. 4.

The microphase separated structure in the present embodiment, shown in (d) of FIG. 4, is added with polymers 13 (refer to (b) of FIG. 2) so as to satisfy above described Formula (1), and thereby, a structure in which the cylindrical microdomains 20b, which were lying as shown in (b) of FIG. 4, are oriented along the direction perpendicular to the substrate 40 (penetration direction through the film).

As described above, the form of a microphase separated structure of a polymer thin film 30 greatly changes with the ratio between the first segments 12, second segments 22 and polymers 13 which constitute the polymer thin film 30.

A substrate 40 is preferably a Si wafer, while allowing appropriate selection of other materials, such as glass, ITO and resin, suitable for a purpose.

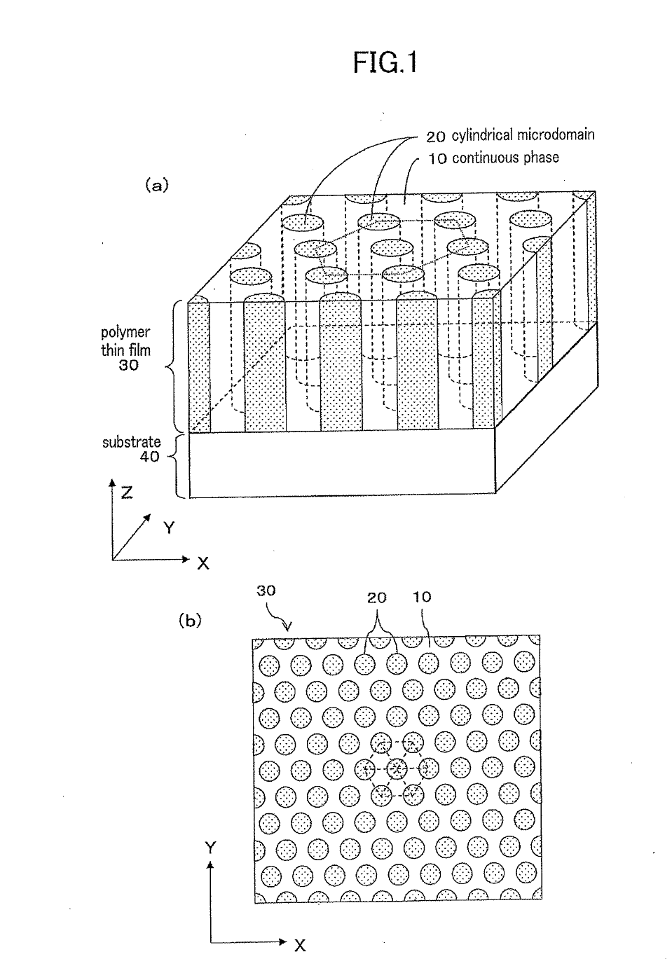

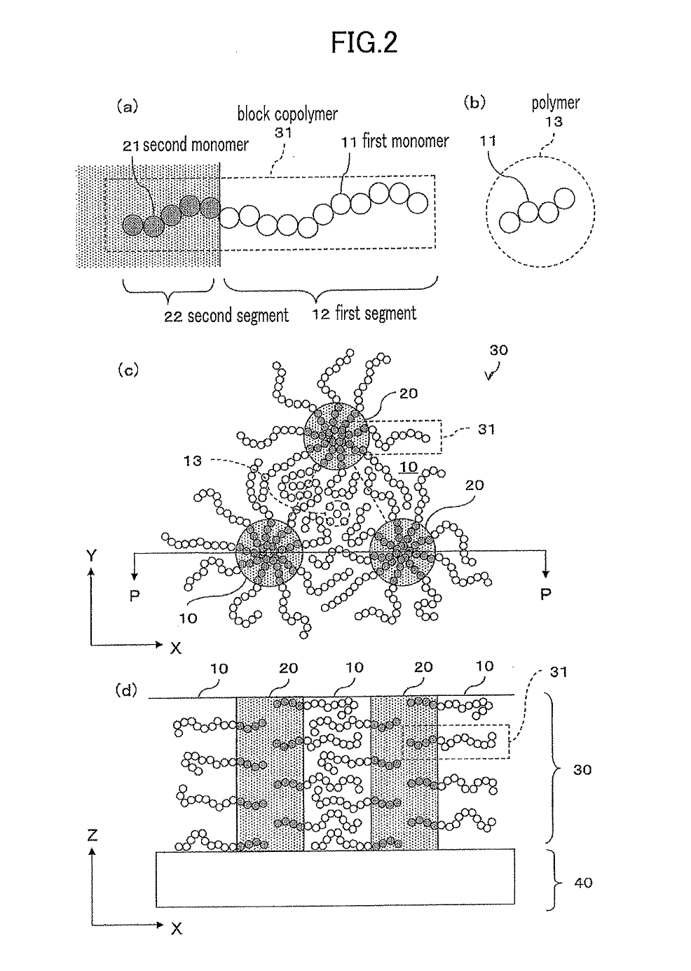

A polymer thin film 30 formed on a flat substrate 40 with a large surface, as shown in FIG. 5, may have a grain structure formed with a number of regions having different array regularities of cylindrical microdomains 20. Also in the grain, there may be a case where the array of cylindrical microdomains 20 has point defects and line defects. Accordingly, there may be cases where such a polymer thin film 30 can not be applied as it is, to purposes which require a high regularity over a large area, such as processing of a later described patterned medium for magnetic recording.

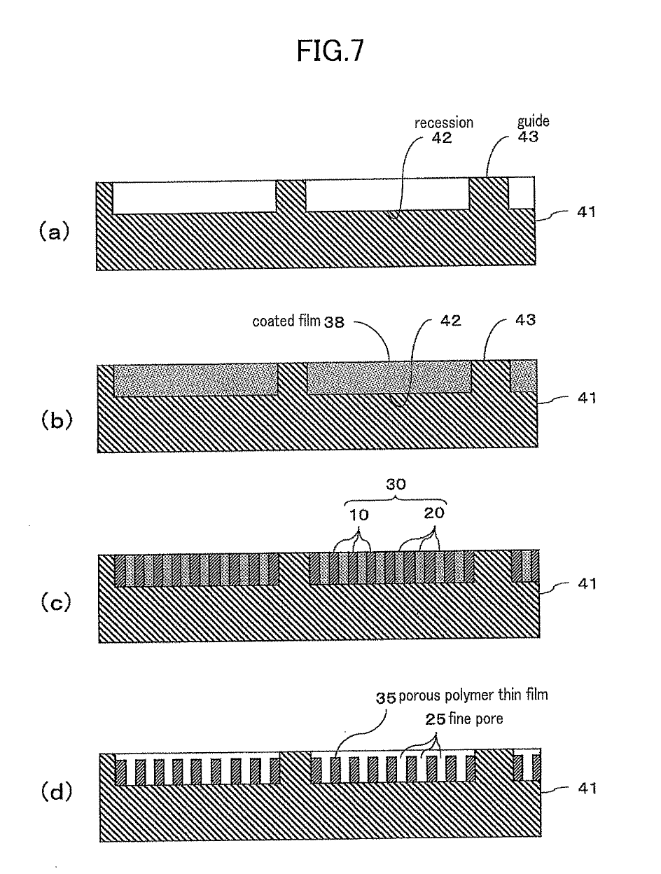

As shown in FIG. 7, the surface of a substrate 41 may not be flat and formed with recessions 42 and guides 43. By processing the surface of the substrate 41 in such a manner, creation of a particle field which disturbs the regularity of the regular array pattern of cylindrical microdomains 20 in a continuous phase 10 is prevented in the polymer thin film 30 formed in a recession 42.

Photolithography is an example of a method of forming such recessions 42 and guides 43 on the surface of a substrate 41. Through creation of a microphase separated structure in the spaces of the recessions 42, the space being enclosed or constrained by the guides 43, a polymer thin film 30 can be formed on the substrate 41, wherein creation of defects, grains, particle field and the like are inhibited.

### (Method of Producing Patterned Substrate)

An embodiment of a method of producing a polymer thin film and a patterned substrate will be described below, referring to FIG. 5.

First, a mixture (hereinafter, also referred to as a polymer mixture) of block copolymers 31 (refer to FIG. 2) and polymers 13 are solved in a solvent so as to prepare a solution of the polymer mixture. Then, this solution is coated on the surface of a substrate 40, shown in (a) of FIG. 5, by a spin-coat method, dip-coat method, solvent-cast method or the like. The solvent used here is preferably one in which both the block copolymers 31 and the polymers 13 constituting the polymer mixture are soluble.

In this process, in order to make the thickness of the coated film 38, shown in (b) of FIG. 5, become a predetermined value, it is necessary to adjust the concentration of the polymer mixture, rotation speed or time in the spin-coat method, or the lifting speed in the dip-coat method.

Then, having the solvent vaporize from the solution of the polymer mixture, the coated film 38 is fixed to the surface of the substrate 40. Herein, the thickness of the coated film 38 may be arbitrarily adjusted depending on a purpose. However, in general, the degree of orientation of perpendicular cylindrical microdomains 20 tends to drop as the thickness of the polymer thin film 30, shown in (c) of FIG. 5, increases. Therefore, the thickness of the polymer thin film 30 is preferably smaller than or equal to ten times the diameter of the cylindrical microdomains 20.

Next, the coated film 38 fixed on the substrate 40 is subjected to heating, and, as shown in (c) of FIG. 5, a microphase separated structure with a separation between a continuous phase 10 and cylindrical microdomains 20 being oriented along the direction perpendicular to the substrate 40 is created.

When the coated film 38 fixed in the stage (b) of FIG. 5 is left as it is, the microphase separation in the coated film 38 does not develop sufficiently, and the coated film 38 often has a nonequilibrium structure where a low regularity is present. Accordingly, through heating, the microphase separation sufficiently develops and the structure changes into one having a high regularity and being more equilibrium.

In order to prevent oxidization of the polymer mixture, this heat processing is preferably performed in an atmosphere of vacuum, nitrogen or argon and to a temperature higher or equal to the glass transition temperature of the polymer mixture.

In such a manner, a polymer thin film 30 having a regular array pattern of a microphase separated structure is formed on a substrate 40, and a patterned substrate 61 is produced. Herein, the cross-sectional area of and the disposition interval between cylindrical microdomains 20 constituting the regular array pattern can be properly adjusted by changing the molecular weight and composition of the block copolymers 31 in the polymer mixture, the molecular weight of the polymers 13, and the respective volume ratios of the both.

Next, from the microphase separated structure of the polymer thin film 30, shown in (c) of FIG. 5, the polymer phase of the cylindrical microdomains 20 is selectively removed, and as shown in (d) of FIG. 5, a porous polymer thin film 35 formed with a regular array pattern of plural fine holes 25 is obtained. Though not shown, it is also possible to obtain a polymer thin film formed with a regular array pattern of plural cylindrical structures (cylindrical microdomains 20) by selectively removing the polymer phase of the continuous phase 10. In such a manner, a porous polymer thin film 35 formed with a regular array pattern of plural fine pores 25 or cylindrical structures is formed on the substrate 40, and thus a patterned substrate 62 is produced.

Further, though not describing in details, with reference to (d) of FIG. 5, by peeling off the remaining polymer phase (the porous polymer thin film 35 of the continuous phase 10 in the figure) from the surface of the substrate 40, it is also possible to produce a porous polymer thin film 35 alone as a patterned substrate.

As shown in (d) of FIG. 5, as a method of selectively removing one of the polymer phase of the continuous phase 10 and the polymer phase of the cylindrical microdomains 20 constituting the polymer thin film 30, a method is used in which the difference in the etching rate between the polymer phases is utilized, applying a reactive ion etching (RIE) or another etching method.

To carry out this method, it is necessary to properly select a combination of the first monomer 11 and the second monomer 21 constituting a block copolymer 31, shown in (a) of FIG. 2.

For example, in the case of block copolymers 31 with a combination of the first monomer 11 and the second monomer 21 which are polystyrene and polybutadiene, development processing is possible so as to leave only the polymer phase of the polystyrene segments by ozonization.

Further, in the case of block copolymers 31 with a combination of the first monomer 11 and the second monomer 21 which are polystyrene and polymethylmethacrylate, polystyrene has a higher etching resistance than polymethylmethacrylate against RIE which uses oxygen or CF4 as etchant. Accordingly, applying etching by RIE enables it to obtain a porous polymer thin film 35 for which only the polymer phase of polymethylmethacrylate is selectively removed.

Block copolymers 31 capable of forming a polymer thin film 30 for which only one of two polymer phases can be selectively removed as described above includes, for example, polybutadiene-polydimethylsiloxane, polybutadiene-4-vinylpyridine, polybutadiene-methylmethacrylate, polybutadiene-poly-t-butyl methacrylate, polybutadiene-t-butyl acrylate, poly-t-butyl methacrylate-poly-4-vinylpyridine, polyethylene-polymethylmethacrylate, poly-t-butyl methacrylate-poly-2-vinylpyridine, polyethylene-poly-2-vinylpyridine, polyethylene-poly-4-vinylpyridine, polyisoprene-poly-2-vinylpyridine, polymethylmethacrylate-polystyrene, poly-t-butyl methacrylate-polystyrene, poly-t-butyl methacrylate-polystyrene, polymethylacrylate-polystyrene, polybutadiene-polystyrene, polyisoprene-polystyrene, polystyrene poly-2-vinylpyridine, polystyrene poly-4-vinylpyridine, polystyrene poly dimethylsiloxane, polystyrene poly-N, N-dimethylacrylamide, polybutadiene- sodium polyacrylate, polybutadiene-polyethylene oxide, poly-t-butyl methacrylate-polyethylene oxide, polystyrene polyacrylate, polystyrene polymethacrylate, or the like.

Further, by doping either polymer phase of the continuous phase 10 or cylindrical microdomains 20 with metal atoms or the like, it is also possible to improve the selectivity for etching. For example, when the combination of the first monomer 11 and the second monomer 21 is a block copolymer 31 of polystyrene and polybutadiene, the polymer phase of polybutadiene is easier to be doped with osmium compared with the polymer phase of polystyrene. Utilizing this effect, etching resistance of the domains of polybutadiene can be improved.

On the other hand, the polymer phase of either the continuous phase 10 or the cylindrical microdomains 20 is doped with metal atoms, and accordingly, the polymer thin film 30 is also expected to serve as a membrane reactor that causes catalyst reaction of an introduced material at the boundary. Further, with regard to timing of doping, metal atoms may be doped before generating phase separation into the continuous phase 10 and the cylindrical microdomains 20, and may be doped after generating phase separation.

Next, using the remaining and other polymer phase (porous polymer thin film 35) as a mask, the continuous phase 10 in the case of (d) of FIG. 5 for example, the substrate 40 is subjected to etching by RIE or a plasma etching method. Then, as shown in (e) of FIG. 5, a patterned substrate 63 is formed onto which surface a regular array pattern in a micro separated structure has been transferred through fine pores 25. Then, when the porous polymer thin film 35 remaining on the surface of the patterned substrate 63 is removed by RIE or a solvent, as shown in (f) of FIG. 5, the patterned substrate 63 is obtained with fine pores 25 formed on the surface thereof, the fine pores 25 having a regular array pattern corresponding to the cylindrical microdomains 20.

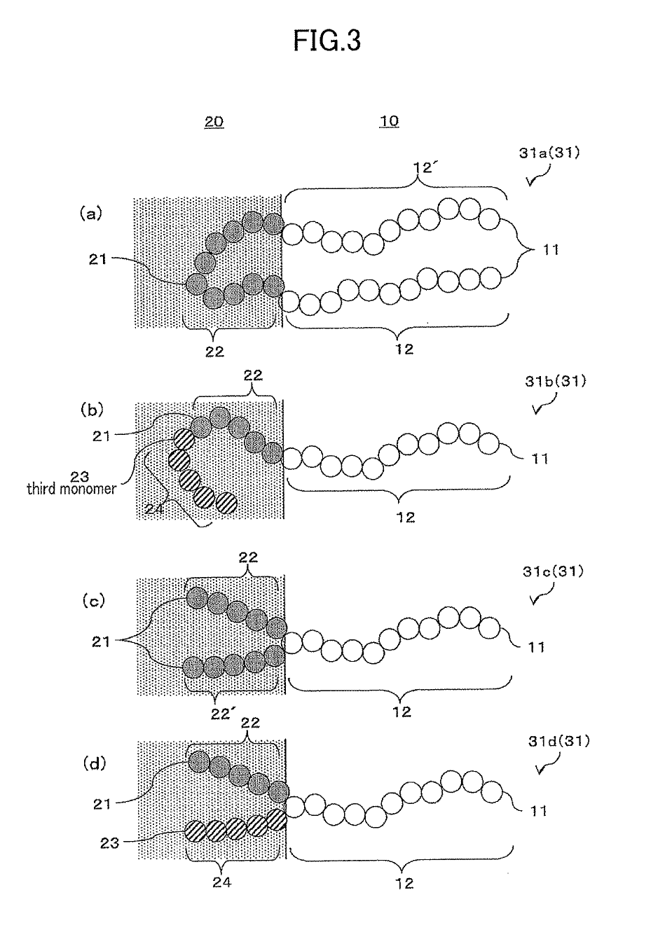

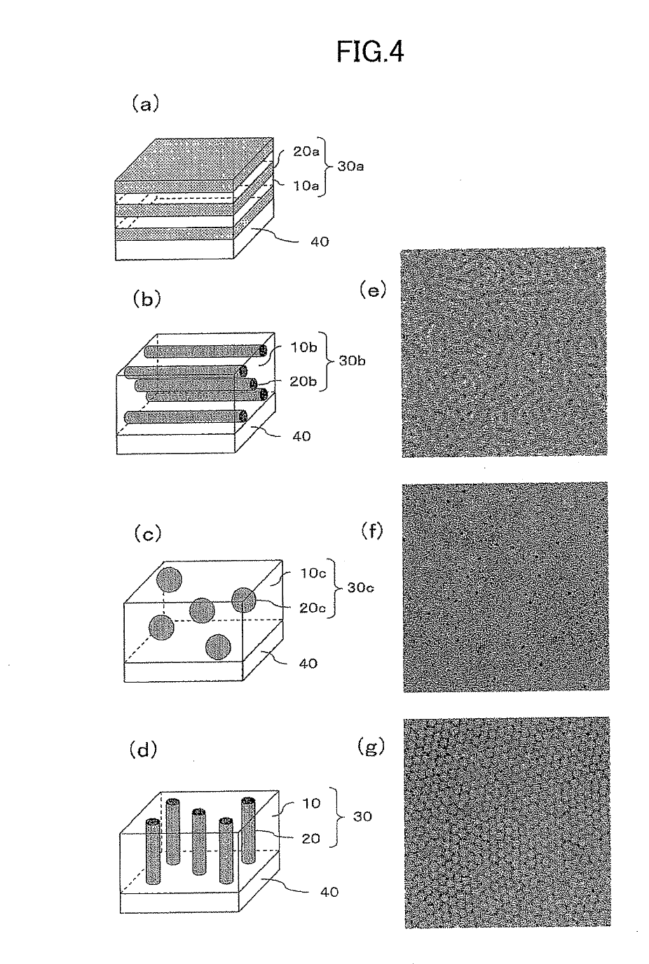

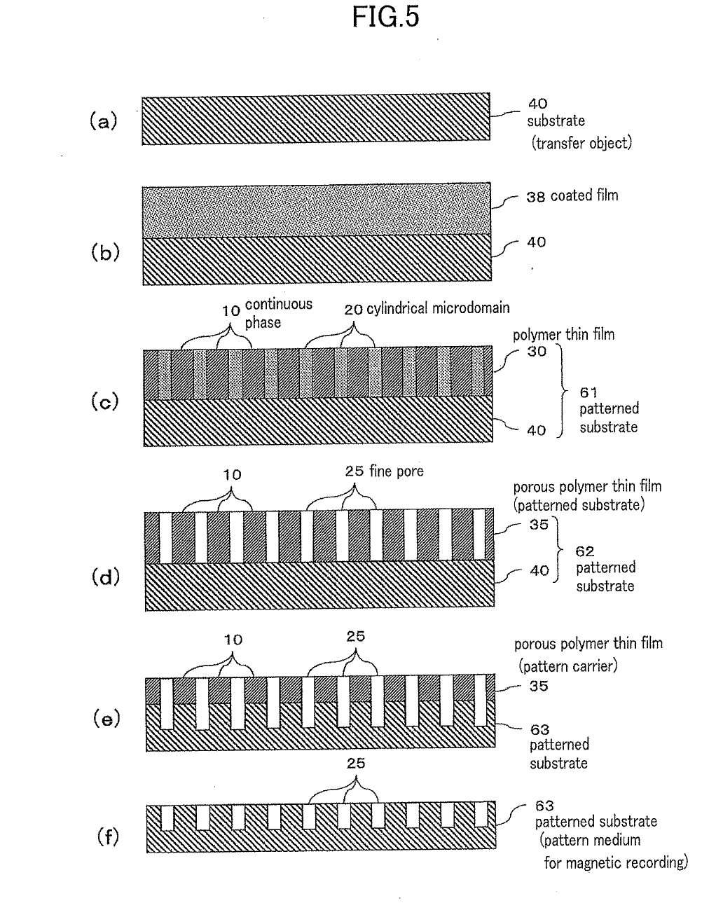

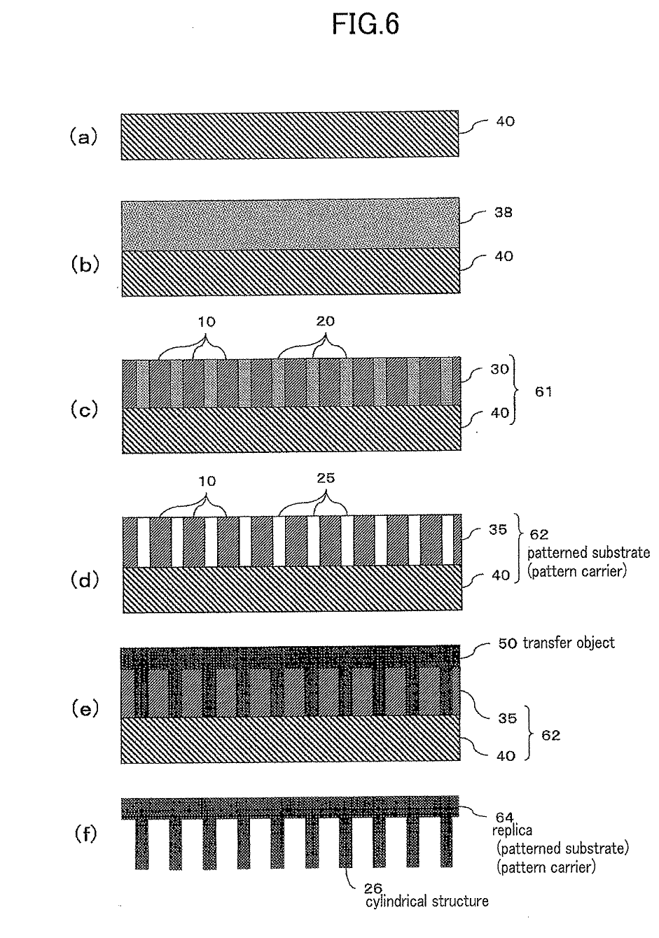

Next, referring to FIG. 6, another embodiment related to a method of producing a patterned substrate will be described.

Herein, the process from (a) to (d) of FIG. 6 is the same as that from (a) to (d) of FIG. 5, and accordingly description of it is omitted.

Utilizing the patterned substrate 62, shown in (d) of FIG. 6, as a pattern carrier, the remaining and other part being the polymer phase (the continuous phase 10) is, as shown in (e) of FIG. 6, made tightly contact a transfer object 50, namely an object to which a pattern is transferred, and thus the regular array pattern of the microphase separated structure is transferred to the surface of the transfer object 50. Thereafter, as shown in (f) of FIG. 6, the transfer object 50 is peeled off from the patterned substrate 62, and thus a replica 64 (patterned substrate) with the regular array pattern transferred from the porous polymer thin film 35 is obtained.

Herein, the material of the replica 64 can be selected from metals including nickel, platinum and gold, from inorganic materials including glass and titania, or from other materials, depending on the purpose. If the replica 64 is made of metal, the transfer object 50 can be made tightly contact with the surface of the patterned substrate 62 by spattering, evaporation, plating, or a combination of them.

Further, if the replica 64 is made of an inorganic material, the transfer object 50 can be made into tight contact by spattering, a CVD method as well as a sol-gel process. Herein, plating and the sol-gel method are preferable methods capable of accurately transferring a fine regular array pattern in a size of several dozen nanometers of a microphase separated structure, and lowering the cost by a non-vacuum process.

By the above described method of producing a patterned substrate, a patterned substrate can be produced which has a fine regular array pattern with a large aspect ratio on the surface thereof.

### (Pattern Carrier and Patterned Medium for Magnetic Recording)

Since a patterned substrate obtained by the above described producing method has on the surface thereof a regular array pattern which is fine and large in aspect ratio, it is applicable to various purposes.

For example, by making the surface of the produced patterned substrate tightly and repeatedly contact with a transfer object by a nanoimprinting method or the like, it can be used for a purpose of mass production of replicas of pattern carriers having the same regular array patterns on the surfaces thereof.

Methods of transferring a fine regular array pattern of the surface of a pattern carrier to a transfer object by nanoimprinting method will be described below.

The first one is a method of transferring a regular array pattern by direct imprinting of a pattern carrier 63 produced as shown in (f) of FIG. 5 to a transfer object (not shown), which is called a thermal imprint method. This method is applied to a case where the transfer object is made of a material allowing direct imprinting. For example, in a case of a transfer object of a thermoplastic resin represented by polystyrene, after heating the thermoplastic resin up to or higher than the glass transition temperature, the pattern carrier 63 is pressed to tightly contact with the transfer object, then cooled down to or lower than the glass transition temperature, thereafter the pattern carrier 63 is peeled off from the surface of the transfer object, thereby obtaining a replica.

As the second method, in a case where the pattern carrier 63 is made of a phototransmitting material, such as glass, a photo-curable resin is employed as the transfer object (not shown), and this method is called a photo-imprint method. This photocurable resin is made tightly contact with the pattern carrier 63 and then irradiated with light, thereby the photocurable resin is cured, then the pattern carrier 63 is peeled off, and the photo-curable resin (the transfer object) after curing is used as a replica.

Further, in a case of employing a substrate of glass or the like as a transfer object (not shown) in such a photo-imprint method, it is also possible to have the pattern carrier 63 and the substrate as the transfer object in tight contact with each other, irradiate light at the nip therebetween, and, after having the photo-curable resin cured, the pattern carrier 63 is peeled off, then the photo-cured resin having a relief on the surface thereof is used as a mask for etching by plasma, ion beams or the like, and thereby the regular array pattern is transferred onto the substrate.

Pattern carriers applicable in the first and second methods described above may be the patterned substrate 63, shown in (f) of FIG. 5, as well as the patterned substrate 62, shown in (d) of FIG. 5, and the pattern 64 prepared, as shown in (f) of FIG. 6. When executing a thermal imprint method using the patterned substrate 62 prepared, as shown in FIG. 5, as the pattern carrier, it is necessary to employ a material with a softening temperature higher than that of the thermoplastic resin for the transfer object (not shown), for the porous polymer thin film 35.

Now, a patterned medium for magnetic recording will be described.

Prior to describing the present embodiment, a magnetic recording media will be described.

For a magnetic recording media, it is always required to improve the density of recording data. Therefore, dots on a recording medium, each of which being a basic unit for recording data, are made minute, and the interval between dots is narrowed for high density.

In order to construct a recording medium with a recording density of 1 terabit /inch², it is understood that the periodic cycle of the array pattern of dots needs to be approximately 25 nanometers.

If the density of dots is made higher, there may be a problem that magnetism applied for switching a dot ON/OFF affects adjacent dots.

Therefore, in order to eliminate affects by magnetism leaking from adjacent dots, a method is considered which forms an array pattern by physically dividing regions of dots on a magnetic recording medium.

That is, for the patterned medium for magnetic recording described here, a regular array pattern of a patterned substrate produced in accordance with the invention is used, and thereby formed is an array pattern of dots of such a magnetic recording medium. Description will be continued, referring to FIG. 5.

A material, such as glass or aluminum, is used for a substrate 40 for this patterned medium for magnetic recording. Then, as described above, the surface of the substrate 40 is processed, according to (a) to (f) of FIG. 5, to obtain a patterned medium 63 for magnetic recording, thereafter a magnetic recording layer is formed on the surface of the patterned medium 63 by spattering or the like, and thus a magnetic recording medium is produced.

On the other hand, it is also possible to process a patterned medium for magnetic recording, by a nano-imprint method, such as photo-imprinting or thermal-imprinting, using a patterned substrate 62, 63 or 64, shown in (d) of FIG. 5, (f) of FIG. 5 or (f) of FIG. 6, as the pattern carrier.

Specifically, a substrate of a patterned medium for magnetic recording before forming a regular array pattern is coated with a thermoplastic resin or photo-curable resin to form a film, and the regular array pattern in a relief is transferred to the coated film. The coated film to which the regular array pattern with relief is transferred is used as a mask for etching by plasma, ion beams or the like, and thus the relief of the regular array pattern is formed on the substrate. This method is more preferable in terms of cost and productivity.

In the above, a polymer thin film 30 has been described mostly with regard to a purpose of producing the patterned substrates 61, 62, 63 or 64 to which the regular array pattern on the surface of the polymer thin film 30 is transferred. However, a polymer thin film 30 is used without being limited to such a purpose, and for example, there is also a purpose of producing a porous polymer thin film 35 to be used alone as a filter.

Further, a regular array pattern having hexagonal close-packed structures has been illustrated in the above description. However, without being limited thereto, a regular array pattern may have a square array. Still further, the scope of protection of a polymer thin film in accordance with the invention is not limited to a case of having a regular array pattern, and includes a case of having an irregular array pattern.

### EMBODIMENT 1

In the present embodiment, in accordance with the process shown in (a) to (c) of FIG. 5, an example will be described where a polymer thin film 30 having a structure with cylindrical microdomains 20 of polymethylmethacrylate (PMMA) arrayed in a continuous phase 10 of polystyrene (PS) is formed on a substrate 40. An example will be illustrated, where, in accordance with the process shown in (c) and (d) of FIG. 5, the cylindrical microdomains 20 of PMMA in the polymer thin film 30 are decomposed and removed, and a porous polymer thin film 35 is formed on the surface of a substrate 40.

Herein, block copolymers 31 (hereinafter, referred to as PS-b-PMMA) with PS as the first segments 12 (refer o (a) of FIG. 2) and PMMA as the second segments 22 (hereinafter, referred to as PMMA segments), and polymers 13 (refer to (b) of FIG. 2) (hereinafter, referred to as homo-PS) of PS were mixed to prepare a polymer mixture.

The prepared polymer mixture was dissolved in a solvent of toluene, and polymer mixture solution with a concentration of 1.0 weight % was prepared. This polymer mixture solution was dropped on the surface of the substrate 40 for spin coating, and thus a coated film 38 was formed on the surface of the substrate 40, as shown in (b) of FIG. 5. Herein, the rotation speed of a spin coater was adjusted so as to make the thickness of the coated film 38 be 100 nm.

Herein, a Si wafer was employed for the substrate 40. Before using the substrate 40 for experiment, the surface of the substrate 40 was sufficiently cleaned by immersing the substrate 40 in a mixed solution (piranha solution) of concentrated sulfuric acid and hydrogen peroxide solution in a ratio of 3:1 at 60° C. for ten minutes.

The polymer mixture of PS-b-PMMA and homo-PS used here will be described in detail below. First, the number average molecular weight Mn of the respective segments constituting PS-b-PMMA were 46,000 for PS segments and 21,000 for PMMA segments. The molecular amount distribution Mw/Mn as the whole PS-b-PMMA was 1.09. Mn was 7,500 and Mw/Mn was 1.09 for homo-PS.

These samples will be referred to respectively as PS(46 k)-b-PMMA(21 k) and PS(7 k) in the following.

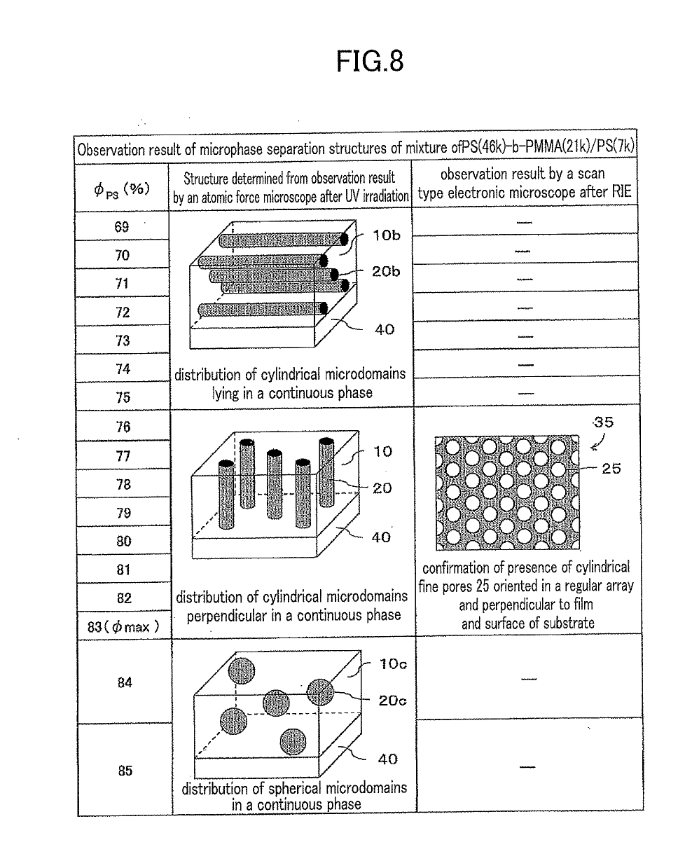

Next, PS(46 k)-b-PMMA(21 k) and PS(7 k) were mixed with each other, and a series of polymer mixtures with different ratios (φ_{PS} (%)) of the sum of the PS segments and homo-PS to the entire polymer mixture were prepared. Herein, φ_{PS} of PS(46 k)-b-PMMA(21 k) alone was 69%. By adding PS(7 k) to PS(46 k)-b-PMMA(21 k), φ_{PS} was adjusted with steps of 1% from 69% to 85% as shown in the left column of FIG. 8.

Then, the surface of the coated film 38 formed on the surface of the substrate 40 was observed by an atomic force microscope (Veeco Instrument Japan made model D-500). As a result, it proved that the surface of the coated film 38 was uniform and the surface of the substrate 40 was coated with a uniform thickness. A part of the coated film 38 was peeled off by a sharp blade, and the step between the portion where the coated film 38 is present and the peeled portion was measured by the atomic force microscope. As a result, the thickness of the coated film 38 proved to be 100 nm.

Next, the substrate 40 formed with the coated film 38 was subjected to heat processing in a vacuum atmosphere at 230° C. for four hours to create a microphase separated structure in the polymer thin film 30 (refer to (c) of FIG. 5). A part of the obtained substrate 40 was cut off, and the microphase separated structure in the polymer thin film 30 was observed by the atomic force microscope.

Observation by the atomic force microscope was carried out by forming a relief derived from a microphase separated structure on the surface of the polymer thin film 30 by the following method. That is, the surface of the polymer thin film 30 was subjected to ashing by irradiating UV-light for six minutes, and the PMMA phase was removed by approximately 5 nm, and thus a relief derived from the microphase separated structure was produced on the polymer thin film 30.

Schematic views of observation results with respective values of φ_{PS} are shown in the left part of FIG. 8. Diagrams (e), (f) and (g) of FIG. 4 show representative observed images by the atomic force microscope.

Diagram (e) of FIG. 4 shows an observed image of a sample with φ_{PS} of 72%. In the most part of the image, cylindrical recessed shapes in a diameter of approximately 20 nm are lying with respect to the film surface. These recessed shapes were formed by etching the PMMA phase by UV, and it proved that the microdomains 20b (refer to (b) of FIG. 4) of PMMA are lying in the continuous phase 10b of PS with respect to the film surface.

Diagram (g) of FIG. 4 shows an observed image of a sample with a φ_{PS} of 80%. A structure in which cylindrical recessed shapes with a diameter of approximately 20 nm are regularly arrayed in the film surface is observed. Herein, the cylindrical recessions are arrayed substantially in a hexagonal close packed structure, with the distance between the centers thereof was approximately 40 nm. These recessed shapes were formed by etching the PMMA phase by UV, and it proved that the cylindrical microdomains 20 (refer to (d) of FIG. 4) of PMMA are present perpendicular to the film surface in the continuous phase 10.

Diagram (f) of FIG. 4 is an observed image of a sample with φ_{PS} of 84%, in which no clear structure is observed. It is understood that no clear structure is observed because the microphase separated structure turned, with the increase in φ_{PS}, into a structure where spherical microdomains 20c (refer to (c) of FIG. 4) are distributed.

Illustrations about the above are shown in the table in FIG. 8. Changing φ_{PS} (%) continuously as such, it proved that a structure, where cylindrical microdomains 20b of PMMA are lying with respect to the film surface, is formed in a region of φ_{PS} from 69% to 75%, a structure where cylindrical microdomains 20 of PMMA are perpendicular to the film surface is formed in a region of φ_{PS} from 76% to 83%, and a structure where spherical microdomains 20c of PMMA are distributed in the film surface is formed in a region of φ_{PS} from 84% to 85%.

Next, based on the above described results, taking samples of φ_{PS} of 76% to 83% which form a structure where cylindrical microdomains 20 of PMMA are perpendicular to the film surface (oriented along the penetration direction through the film), the PMMA phase was removed by RIE, as shown in (d) of FIG. 5, and thus a porous polymer thin film 35 were obtained. Herein, the oxygen gas pressure was set to 1 Pa and the output was set to 20 W. The time for etching was set to 90 seconds. The surface shapes of the produced porous thin films 35 were observed using a scan type electronic microscope.

A representative result is shown in the right part of FIG. 8. This diagram shows a result using a sample with φ_{PS} 80%. It was confirmed that the porous polymer thin film 35 is formed with cylindrical fine pores 25 oriented along the penetration direction through the film. Herein, the diameters of the fine pores 25 are approximately 20 nm, and the state was observed where the fine pores 25 are arrayed substantially in a hexagonal close-packed structure. The distance between the centers of adjacent fine pores 25 was approximately 40 nm. The depth of the fine pores 25 was approximately 80 nm. Herein, a part of the porous polymer thin film 35 was peeled off by the thickness thereof from the surface of the substrate 40 by a sharp blade, and the step between the surface of the substrate 40 and the surface of the porous polymer thin film 35 was measured by the atomic force microscope, resulting in a value of 80 nm.

The above described result proved that the fine pores 25 penetrate from the surface of the porous polymer thin film 35 to the surface of the substrate 40. Further, the aspect ratio of the obtained fine pores 25 was 4, realizing a large value which cannot be obtained by spherical microdomain structures. It is understood that the film thickness of the polymer thin film 30 decreased from 100 nm, which was prior to performing RIE, to 80 nm because the PS continuous phase 10 was also etched a little, along with the PMMA phase through performing RIE.

A series of samples of φ_{PS} of 76% to 83% were evaluated likewise, and similar results were obtained. It was confirmed that a porous polymer thin film 35 was formed with cylindrical fine pores 25 oriented along the penetration direction through a film.

As shown in FIG. 8, using a sample of a substrate on which surface a film of a sample prepared by mixing PS(46 k)-b-PMMA(21 k) with PS(7 k) was formed, a microphase separated structure was created. It was confirmed that when fps is 83% or lower, a cylindrical microphase separated structure is formed, and in a range from 76% to 83%, cylindrical microdomains are oriented perpendicular to the polymer thin film and the surface of the substrate.

### COMPARATIVE EXAMPLE

In the sample prepared by mixing PS(46 k)-b-PMMA(21 k) and PS(7 k) to make φ_{PS} be 81% in such a manner, the cylindrical microdomains 20 were oriented perpendicular to the surface of the substrate 40, as shown in FIG. 8. Herein, the following test was carried out to confirm the effect of adding homo PS.

First, a sample of PS-b-PMMA alone was prepared with φ_{PS} as 81%, and verified the effect of adding homo PS. For the sample, PS-b-PMMA was used of which Mn of PS segments is 89,000, Mn of PMMA segments is 21,000, and molecular weight distribution Mw/Mn is 1.07.

Hereinafter, this sample will be referred to as PS(89 k)-b-PMMA(21 k) for abbreviation. PS(89 k)-b-PMMA(21 k) alone has φ_{PS} of 81%, namely without mixing with homo PS.

By the same method as preparing the above described mixture system of PS(46 k)-b-PMMA(21 k) and PS(7 k), a film of PS(89 k) b-PMMA(21 k) was formed on the surface of a substrate 40 and a microphase separated structure was created by heat processing. The obtained polymer thin film was irradiated with UV and observed by the atomic force microscope, which proved that cylindrical microdomains 20b with a diameter of approximately 21 nm were oriented, as shown in (b) and (e) of FIG. 4, in a state of lying with respect to the surface of the film at an interval of approximately 40 nm.

Next, discussion was made on a case where a sample in which PS-b-PMMA alone has a φ_{PS} of 85% was prepared and the Ups was adjusted to 81% by adding homo PMMA. For the sample, PS-b-PMMA was employed in which Mn of PS segments was 85,000, Mn of PMMA segments was 15,000, and molecular weight distribution Mw/Mn was 1.08. Hereinafter, this sample will be referred to as PS(85 k)-b-PMMA(15 k) for abbreviation.

PS(85 k)-b-PMMA(15 k) alone has Ups of 85%, and forms spherical microdomains 20c. By mixing this sample with homo PMMA with Mn of 5,000 and molecular weight distribution Mw/Mn of 1.10, a polymer mixture was prepared of which fps was adjusted to 81%.

By the same method as preparing the above described mixture system of PS(46 k)-b-PMMA(21 k) and PS(7 k), a film of PS(85 k)-b-PMMA(15 k) and PMMA (5 k) was formed on the surface of a substrate 40 and a microphase separated structure was created by heat processing. The obtained polymer thin film was irradiated with UV and then observed by the atomic force microscope, which proved that cylindrical microdomains 20b with a diameter of approximately 20 nm were oriented in a state of lying with respect to the surface of the film at an interval of approximately 42 nm.

From the above results, it proved that, a microphase separated structure, in which cylindrical microdomains 20 of PMMA are oriented perpendicular to the substrate 40 in a continuous phase 10 of PS, can be formed by mixing PS-b-PMMA with polymer (PS) of the same monomer as PS segments forming the continuous phase such that the above described Formula (1) is satisfied.

### EMBODIMENT 2

An embodiment will be described below, where, by the same method as in Embodiment 1, a polymer thin film was formed which has a structure in which cylindrical microdomains 20 of polystyrene (PS) are arrayed in a continuous phase 10 of polymethylmethacrylate (PMMA) in a state where the cylindrical microdomains 20 are oriented perpendicular to a substrate 40.

A polymer mixture of diblock copolymers (PS-b-PMMA), composed of PS segments and PMMA segments, and homo PMMA was used for discussion.

The polymer mixture used for discussion will be described below in detail. The number average molecular weight Mn of each segment constituting PS-b-PMMA is 20,000 for PS segments and 50,000 for PMMA segments. The molecular weight distribution Mw/Mn as the entire PS-b-PMMA was 1.09. Mn of homo PMMA was 6,500 and Mw/Mn thereof was 1.07. Hereinafter, these samples will be referred to as PS(20 k)-b-PMMA(50 k) and PMMA(6 k).

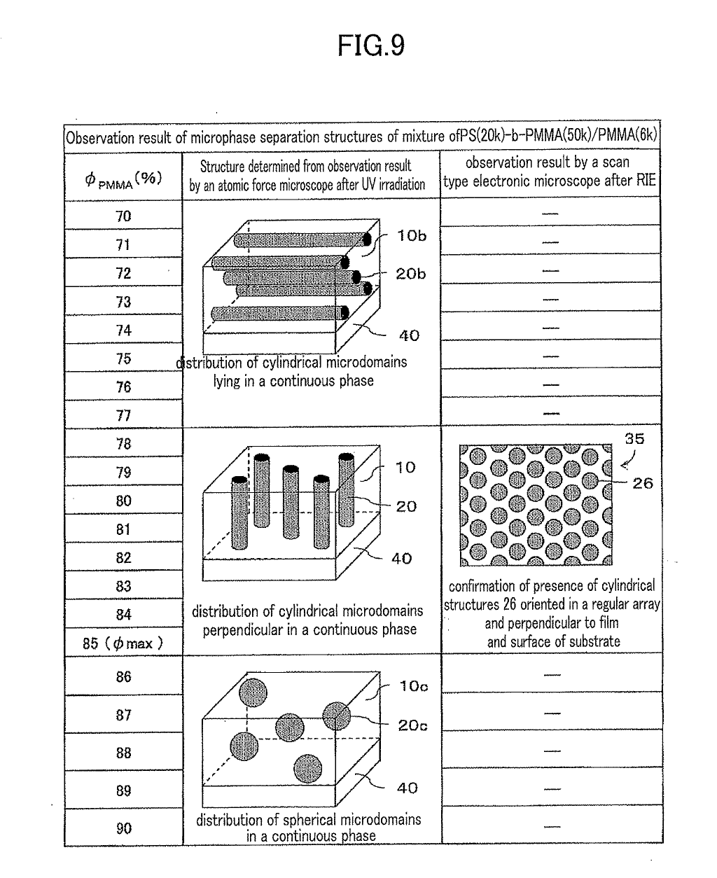

A series of polymer mixtures were prepared by mixing PS(20 k)-b-PMMA(50 k) and PMMA(6 k) such that the respective ratios (volume ratio: φ_{PMMA} (%)) of the sum of the volumes of the PMMA segments and homo PMMA to the entire polymer mixture are different from each other. Although PS(20 k)-b-PMMA(50 k) alone has φ_{PMMA} of 71%, φ_{PMMA} was adjusted with steps of 1% from 71% to 87% by adding PMMA(6 k) to PS(20 k)-b-PMMA(50 k). Obtained results are shown in the left part of FIG. 9.

A microphase separated structure was created by forming on the surface of a substrate a film of a sample prepared by mixing PS(20 k)-b-PMMA(50 k) and PMMA(6 k) in such a manner. The obtained film was irradiated with UV and then observed by the atomic force microscope, which confirmed that a cylindrical microphase separated structure was formed with φ_{PMMA} lower than or equal to 85%, and cylindrical microdomains 20 were oriented perpendicular to the surface of the substrate in a region from 78% to 85%.

Further, a representative observation result after RIE processing is shown in the right part of FIG. 9. FIG. 9 shows a result of a case of using a sample with φ_{PMMA} of 82%. It was confirmed that cylindrical structures 26 perpendicular to the surface of the substrate 40 were formed on the surface of the substrate 40.

Herein, the diameter of the cylindrical structures 26 were approximately 20 nm, and a state was observed where they were arrayed substantially in a hexagonal close-packed structure. The distance between the centers of adjacent cylindrical structures 26 was approximately 40 nm. Further, the height of the cylindrical structures 26 was approximately 70 nm. From the above results, it proved that the aspect ratio of the obtained cylindrical structures 26 was 3.5.

From the above results, it was verified that a microphase separated structure can be formed in which cylindrical microdomains 20 of PS in the continuous phase 10 of PMMA are oriented perpendicular to the substrate 40, by mixing PS-b-PMMA with polymers (PMMA) of the same monomer as the PMMA segments forming the continuous phase such as to satisfy Formula (1).

### EMBODIMENT 3

An embodiment will be described below, where, by the same method as in Embodiment 1, a polymer thin film is formed, on a substrate 40, which has a structure in which cylindrical microdomains 20 of polymethylmethacrylate (PMMA) are arrayed in a continuous phase 10 of polystyrene (PS).

A polymer mixture of diblock copolymers (PS-b-PMMA) composed of PS segments and PMMA segments, and polymers 13 composed of polymethyl vinyl ether (PMVE) compatible with PS segments, was used.

The polymer mixture of PS-b-PMMA and PMVE used here will be described below in detail. First, the number average molecular weight Mn of each segment constituting Ps-b-PMMA was 46,000 for PS segments and 21,000 for PMMA segments. The molecular weight distribution Mw/Mn as the entire PS-b-PMMA was 1.09. Further, Mn of PMVE was 8,700 and Mw/Mn was 1.05. Hereinafter, these samples will be referred to as PS(46 k)-b-PMMA(21 k) and PMVE(9 k).

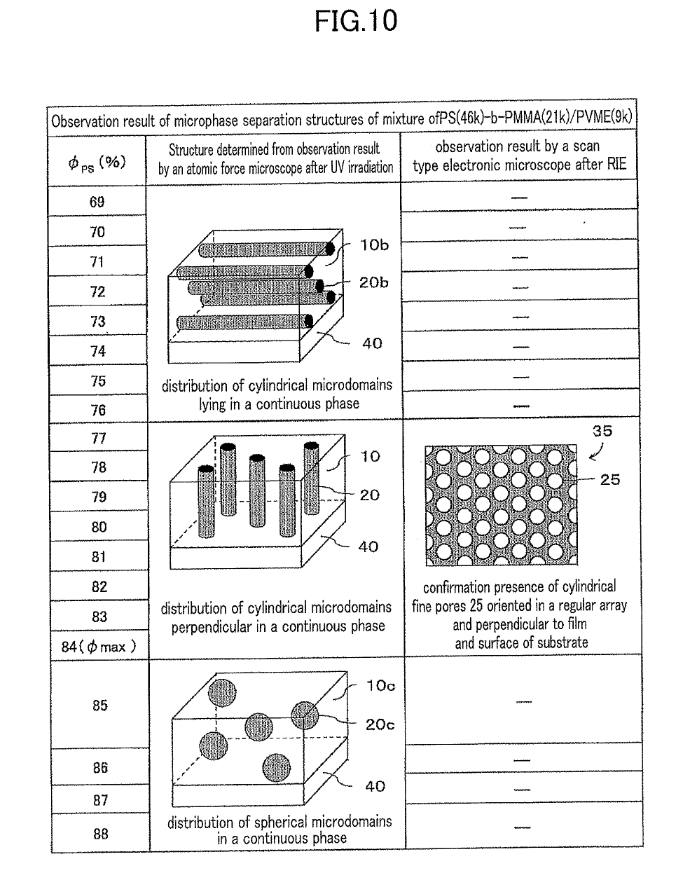

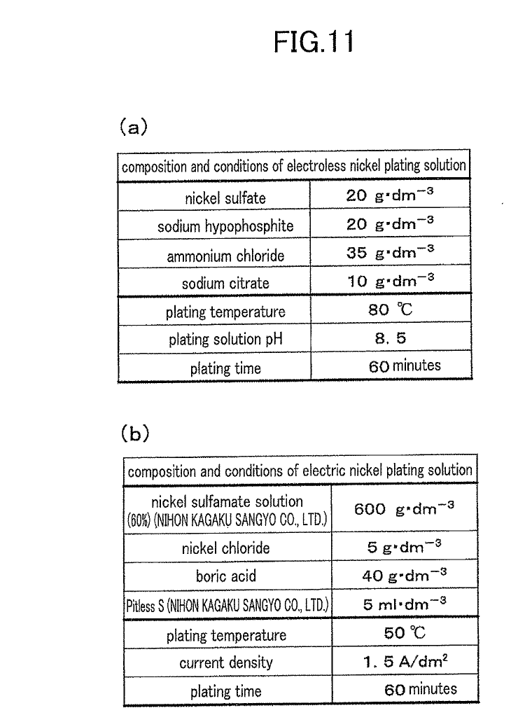

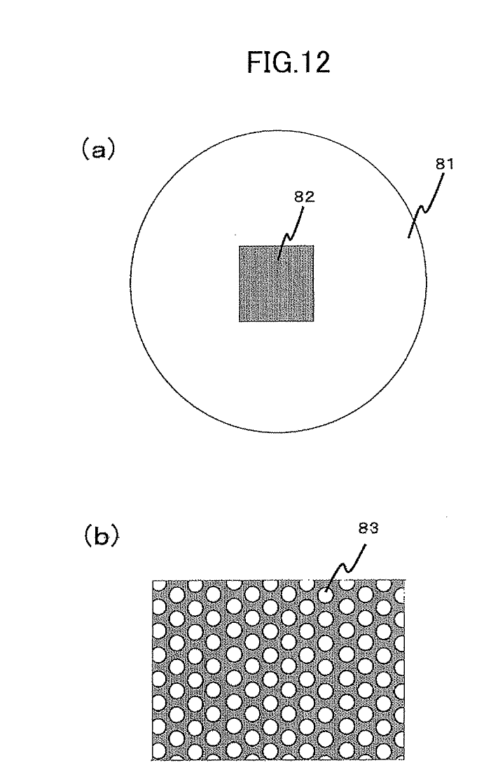

A series of polymer mixtures were prepared by mixing PS(46 k)-b-PMMA(21 k) and PMVE(9 k) such that the respective ratios (φ_{PS+PMVE} (%) ) of the sum of the volumes of the PS segments and PMVE to the entire polymer mixture are different from each other. Although PS(46 k)-b-PMMA(21 k) alone has φ_{PS+PMVE} of 69%, φ_{PS+PMVE} was adjusted with steps of 1% from 69% to 88% by adding PMVE(9 k) to PS(46 k)-b-PMMA(21 k), as shown in the left column of FIG. 10. Obtained results are shown in the left part of FIG. 10.

A microphase separated structure was created by forming on the surface of a substrate a film of a sample prepared by mixing PS(46 k)-b-PMMA(21 k) and PMVE(9 k). The obtained film was irradiated with UV and then observed by the atomic force microscope, which confirmed that there arises a structure in which cylindrical microdomains are lying with respect to the surface of the film with φ_{PS+PMVE} in a range from 69% to 76%, a structure in which cylindrical microdomains of PMMA are perpendicular to the surface of the film with φ_{PS+PMVE} in a range from 77% to 84%, and a structure in which spherical microdomains of PMMA are distributed on the surface of the film with φ_{PS+PMVE} in a range from 85% to 88%.

Herein, the diameter of the cylindrical structures was approximately 21 nm, and a state was observed where they were arrayed substantially in a hexagonal close-packed structure. The distance between the centers of adjacent cylindrical structures was approximately 43 nm. Further, the height of the cylindrical structures was approximately 70 nm. From the above results, it proved that the aspect ratio of the obtained cylindrical structures was 3.5.

From the above results, it was verified that a microphase separated structure can be formed in which cylindrical microdomains 20 of PMMA in the continuous phase 10 of PS are oriented perpendicular to the substrate 40, by mixing PS-b-PMMA with polymers (PMVE) compatible with the PS segments forming the continuous phase such as to satisfy Formula (1).

### EMBODIMENT 4

In the present embodiment, an example will be described where a recessed structure is formed on the surface of a substrate by a top-down method. By forming a microphase separated structure in the recessed structure, namely, in a constrained space, cylindrical microdomain structures are arrayed in a state where extremely few defects, grains, particle fields and the like are present. In the following, according to the process shown in (a) to (d) of FIG. 7, such a microphase separated structure is formed, and thereafter a patterned substrate having a regular array pattern on the entire surface of a substrate 41 is formed.

First, as shown in (a) of FIG. 7, a substrate 41 provided with recessions 42 on the surface thereof is prepared. Herein, the width (L) of the recessions 42 is 350 nm, the depth (d) is 80 nm, and the distance (t) between adjacent recessions 42 is 50 nm. The recessions 42 are arranged in parallel on the surface of the substrate 41. The recessions 42 are processed by the following method. That is, a thin film of SiO₂ with a thickness of 80 nm is laminated on a silicon substrate having a flat surface by plasma CVD, and then an ordinary photolithography process is used, wherein the SIO₂ thin film is etched by dry etching so as to process the recessions 42.

Next, the obtained substrate 41 is immersed in a mixed solution (piranha solution) with a ratio between concentrated sulfuric acid and hydrogen peroxide solution of 3:1 at 60° C. for ten minutes so that the surface thereof is sufficiently cleaned.

According to the method same as in Embodiment 1, a film of a polymer mixed system is formed inside a recession 42 obtained by the above described method, and thus a coated film 38 is obtained. Herein, the polymer mixed system is prepared by adding PS(7 k) to PS(46 k)-b-PMMA(21 k) so that φ_{PS} is adjusted to 80%.

Then, as shown in (b) and (c) of FIG. 7, according to the same process as in Embodiment 1, a microphase separated structure is formed in which cylindrical microdomains 20 of PMMA are arrayed in a continuous phase 10 of PS in a polymer thin film 30, and further, the cylindrical microdomains 20 of PMMA are decomposed by oxygen RIE so as to form fine pores 25 inside the recessions 42.

Observation of the surface of the obtained substrate 41 by the scan type electronic microscope proved that cylindrical fine pores 25 are formed through a porous polymer thin film 35 along the penetration direction through the film. Herein, the diameter of the cylindrical pores was approximately 20 nm, and a state was observed where the cylindrical pores were arrayed in a hexagonal close-packed structure. The distance between the centers of adjacent fine pores 25 was approximately 40 nm. The depth of the fine pores was approximately 60 nm. Further, it was confirmed that these fine pores 25 were arrayed along the side walls of the respective recessions 42, in a hexagonal close-packed structure. Still further, the region of 10 micron square was observed with a lower magnification of the electronic microscope, and no particle field or the like that distorts the array of the fine pores 25 was observed. Yet further, the directions of orientation of the fine pores 25 in the recessions 42 were all the same.

The above described results proved that, by forming a structure including recessions 42 on the surface of a substrate 41 by a top-down method and forming a micro separated structure inside the structures, namely, constrained spaces, cylindrical microdomains 20 can be arrayed in a state where extremely few defects, grains, particle fields and the like are present.

### EMBODIMENT 5

Referring to FIG. 6, a method, by plating with a nickel film, of producing a replica 64 of the porous polymer thin film 35 having cylindrical fine pores 25 prepared by the method described in Embodiment 1 will be described below. First, according to the process shown in (a) to (d) of FIG. 6, a porous polymer thin film 35 with fine pores 25 was produced, using the same sample and same method as in Embodiment 1. Herein, PS(46 k)-b-PMMA(21 k) added with PS(7 k) was used with φ_{PS} adjusted to 80%.

Then, the surface of the porous polymer thin film 35 was subjected to electroless nickel plating. Further, electric nickel plating was performed with the electroless nickel plating layer as a power supply layer, and thus a nickel thin film with a thickness of 20 μm was formed as a transfer object 50 on the surface of a patterned substrate 62 (refer to (e) of FIG. 6).

The following method was applied for the electroless nickel plating. First, a substrate 40 having a porous polymer thin film 35 (hereinafter, referred to merely as a substrate 40) was immersed in cleaning solution (Securiganth 902 made by ATOTECH Japan) for promoting addition of catalyst for electroless plating, at 30° C. for five minutes. Then, the substrate was sufficiently cleaned with pure water and immersed in pre-dip solution (Neoganth B made by ATOTECH Japan) at a room temperature for one minute in order to prevent contamination of the catalyst solution. Thereafter, the substrate 40 was immersed in a catalyst solution (Neoganth 834 made by ATOTECH Japan) at 40° C. for five minutes. The catalyst used here is a solution with palladium complex molecules dissolved in it. After adding the catalyst, the substrate was immersed in a pure water to be cleaned, and was activated with the added palladium as a core, using Neoganth W solution made by ATOTECH Japan.

Finally, by cleaning with pure water, the substrate 40 provided with a catalyst layer for electroless plating precipitation was obtained. Then, the substrate 40 subjected to addition of catalyst was immersed in an electroless nickel plating solution for 30 seconds, and thus a nickel plated film was precipitated on the entire surface of the porous polymer film 35 on the substrate 40. The composition of the electroless nickel plating solution and the plating conditions used here are shown in (a) of FIG. 11. The pH of the plating solution was adjusted using an ammonia solution.

Electric nickel plating was carried out by the following procedure. That is, making a lead by a conductive tape from the periphery of the nickel plated film precipitated covering the entire surface of the porous polymer thin film 35 by electroless nickel plating, and having a nickel plate serve as the return electrode, electric nickel plating was performed by the use of sulfamic acid Ni plating solution made by Nihon Kagaku Sangyo-sha. The composition of the plating solution and the plating conditions are shown in (b) of FIG. 11.

Finally, the nickel thin film 50 obtained by the above described method was peeled off from the porous polymer thin film 35, and thus a replica 64 having fine pore structures was obtained ((f) of FIG. 6). The surface structure of the replica 64 of the obtained nickel film was observed by a scan type electronic microscope (S-4800 made by Hitachi High-Technologies Corporation), and it was proved that fine cylindrical structures 26 with a diameter of 20 nm and height of 80 nm were present with the distance between the centers of adjacent cylindrical structures 26 of 40 nm on the entire surface of the nickel film in such a manner that the cylindrical structures are arrayed in a hexagonal close-packed structure in a substantially regular state without defects, grains, or particle fields.

### EMBODIMENT 6

As Embodiment 6, an example of processing a substrate 40 by dry etching will be described below, wherein, as a mask, used is a porous polymer thin film 35 with cylindrical fine pores 25 produced by the method described in Embodiment 1 through the process shown in FIG. 5. First, according to the process shown in (a) to (d) of FIG. 5, a porous polymer thin film 35 having fine cylindrical pores 25 was prepared by the use of the same sample and same method as in Embodiment 1. Herein, φ_{PS} was made 80%. For the substrate 40, a SiO₂ thin film with a thickness of 100 nm was laminated by plasma CVD on the surface of a silicon substrate.

Herein, it was confirmed that the porous polymer thin film 35 was formed with cylindrical fine pores 25 along the penetration direction through the film. The diameter of the cylindrical pores was approximately 20 nm, and a state was observed where the cylindrical pores were oriented substantially in a hexagonal close-packed structure. The distance between centers of adjacent fine pores 25 was approximately 40 nm. The depth of the fine pores 25 was approximately 80 nm. Further, it was confirmed that the fine pores 25 penetrate from the surface of the porous polymer thin film 35 to the surface of the substrate 40.

Next, the SiO₂ thin film on the surface of the substrate 40 was subjected to dry etching by C₂F₆ gas with the fine pores 25 as a mask. As the etching conditions, the output power was set to 150 W, the gas pressures was set to 1 Pa, and the etching time was set to 60 seconds. After etching the SiO₂ layer, the porous polymer thin film 35 remaining on the surface of the substrate was removed by oxygen plasma processing (30 W, 1 Pa and 120 seconds), and thus a patterned substrate 63 formed with fine pores 25 was produced, as shown in (f) of FIG. 5.

Herein, the obtained patterned substrate 63 was observed by the scan type electronic microscope. The diameter of the fine pores 25 was 20 nm, and a state was observed where hexagonal closed-pack structures forming triangle lattices were substantially regularly arrayed with the distance between the centers of adjacent fine pores 25 of 40 nm. Further, the patterned substrate 63 was processed by convergent ion beams, and the cross-sectional structure of the substrate was observed by the scan electronic microscope, which proved that the depth of the fine pores 25 was 50 nm without variation.

### EMBODIMENT 7

In the present embodiment, an example will be described where a nickel film having on the surface thereof a regular array pattern, produced by a process equivalent to the method disclosed by Embodiment 4, was used as a stamper for a nano-imprint method.

First, a nickel stamper 81 produced for experiment is schematically shown in (a) of FIG. 12. The outer diameter of the nickel stamper 81 is 4 inch φ and 25 μm thick. In a 2.5 cm square area 82 in the central part of the stamper 81, fine pores 83 with a diameter of 20 nm and a height of 80 nm are regularly arrayed to form hexagonal close-packed structures. An enlarged view of the 2.5 cm square area in the central part is shown in (b) of FIG. 12. The nickel stamper 81 was produced by the same method as in Embodiment 5.

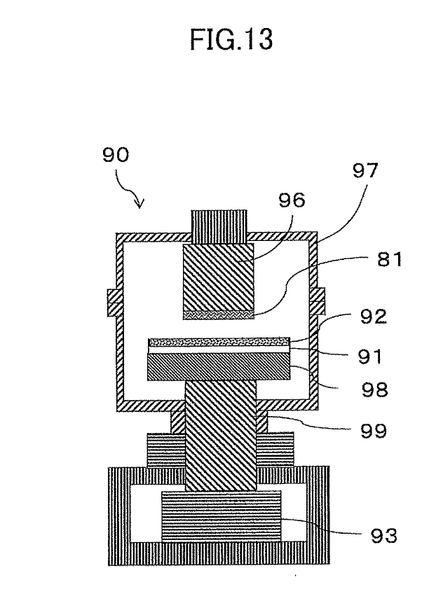

FIG. 13 is a schematic view of a prototype nao-priniting device 90 by the use of the stamper 81.

The procedure will be described below. First, a peeling agent for easy release in resin forming was coated on the surface of the stamper 81. A polydimethylsiloxane group peeling agent was employed as the peeling agent.

Next, a process of forming of resin by the use of the stamper 81 coated with the peeling agent will be described. First, a polystyrene resin 92 (Polystyrene 679 made by A & M) was spin coated with a thickness of 600 nm on a Si substrate 91 (4 inch φ and 0.5 mm thick) . The stamper 81 coated with the peeling agent was fitted with positioning, and thereafter set above a stage 98.

The stage 98 has a structure capable of moving horizontally and vertically to an arbitrary position by a driving section 93 connected to the stage 98 through a support 99.

The nano-printing device 90 has a vacuum chamber 97, and the stage 98 is provided with a heating mechanism. The pressure inside this vacuum chamber 97 was reduced to 0.1 Torr or lower and the vacuum chamber 97 was heated to 250° C. Then, the stamper 81 held by a support 96 driven up and down was pressed at 12 MPa against the polystyrene resin 92 for 10 minutes. Then, the vacuum chamber was left until the temperature dropped to 100° C. or lower, and then released to the atmosphere. A peeling tool was adhesively fixed at the back side of the stamper 81 at the room temperature, and the stamper 81 was lifted in the vertical direction at a speed of 0.1 mm/s. Thus, the shape of the stamper surface was transferred to the surface of the polystyrene resin.

Next, using the stamper 81 coated with the same peeling agent, the above described resin forming process was repeated 100 times so as to obtain one hundred pieces of formed resin products to which the shape of the stamper surface was transferred. The surface of the central part of each of the obtained formed resin products was observed by the atomic force microscope, and for all the formed polystyrene resin products, a state was observed where cylindrical fine pores form hexagonal close-packed structures arrayed substantially regularly with almost no defects. The diameter of the fine pores was 20 nm and the distance between the centers of adjacent pores was 40 nm. From the above, it was confirmed that it is possible to transfer the surface shape of the stamper accurately to the surface of a polystyrene resin.

### EMBODIMENT 6

A method of producing a patterned medium for magnetic recording in accordance with the invention will be described below. This method includes a process of producing a patterned substrate by self assembly of block copolymers, a process of producing a replica of the patterned substrate by nickel plating, a process of forming a fine pattern on the surface of a glass substrate for a patterned medium for magnetic recording, with the nickel plated replica as a stamper (pattern carrier), and a process of forming a magnetic film on the surface of the patterned medium, having been produced, for magnetic recording.

First, the process of producing a patterned substrate of a polymer thin film by self assembly of block copolymers will be described.

First, a SiO₂ layer with a thickness of 80 nm was formed by a CVD method on a surface of a silicon substrate with a thickness of 2.5 inches. Then, applying an ordinary photo-lithography process, the SiO₂ layer was etched so as to form concentric grooves with a depth of 80 nm and width of 200 nm at an interval of 1000 nm. Next, according to the process described in Embodiment 2, a patterned substrate with fine convex shapes of PS which are regularly arrayed was produced. Herein, used was a sample of which φ_{PMMA} was adjusted to 80% by adding PMMA(6 k) to PS(20 k)-b-PMMA(50 k).

The surface of the obtained patterned substrate was observed by the atomic force microscope. A microscopic state was observed where fine cylindrical structures of PS with a diameter of 20 nm and a height of 70 nm were regularly arrayed with almost no defects on the surface of the patterned substrate and form triangle lattices with a hexagonal close-packed structure with a distance of 30 nm between the centers of adjacent cylindrical structures. Further, when macroscopic observation was made with a lower magnification of the atomic force microscope, it was proved that the regular structure formed by the fine cylindrical structures of PS were arrayed concentrically with a center at the center of the patterned substrate, with almost no defects.

Next, according to the method described in Embodiment 5, the surface of the patterned substrate on which the fine cylindrical structures of PS were regularly arrayed was subjected to nickel plating, and produced was a stamper for nanoimprint of nickel film with a thickness of 25 μm having a replica shape which was formed by reverse transfer of the surface structure. The surface of the obtained stamper was observed by the scan type electronic microscope, and it was confirmed that fine cylindrical pores with a diameter of 20 nm were regularly formed on the surface of the nickel film.

On the surface of a glass substrate with a diameter of 2.5 inches in a torus-shape with a hole of a diameter of 0.5 inch at the center thereof, a Pd foundation layer with a thickness of approximately 30 nm and a film of CoCrPt layer with a thickness of approximately 30 nm were formed, and thus a magnetic layer was produced. Then, a PS layer with a thickness of 50 nm was formed on the surface of the magnetic layer by a spin coat method. The molecular weight Mn of the PS used here was 5,000. The PS thin film on the surface of the magnetic layer was subjected to nanoimprint by the same method as that described in Embodiment 7, using a stamper obtained by the above described method. When the PS thin film on the surface of the obtained magnetic layer was observed by the atomic force microscope, it was confirmed that fine cylindrical structures with a diameter of 20 nm were formed regularly in the PS thin film. Herein, the shapes and positions of the fine cylindrical structures were the reverse transfer of the shapes and positions of the fine pores on the surface of the stamper. Further, the cross-sections of the fine convex shapes were measured in detail by the atomic force microscope, and the height of the fine convex shapes was 50 nm.

Next, the magnetic layer was etched by Ar ion milling, using the fine cylindrical structures of PS produced on the surface of the magnetic layer as a mask. Through this process, all of the PS thin film was lost. The surface of the obtained glass substrate was observed in detail by the atomic force microscope, and a microscopic state was observed where fine convexes of a magnetic layer with a diameter of 20 nm and a height of 30 nm form triangle lattices with a hexagonal close-packed structure with a distance of 30 nm between the centers of adjacent convex magnetic layers on the surface of the substrate. The fine convexes were regularly arrayed with almost no defects. Further, macroscopic observation was made with a lower magnification ratio of the atomic force microscope, and it was proved that the regular structures formed by the fine convexes of the magnetic layer were arrayed concentrically with a center at the center of the substrate with almost no defects.

Finally, a SiO₂ layer with a thickness of 30 nm was formed on the entire surface of the obtained substrate, and the obtained surface was made flat by CMP grinding. Thereafter, a carbon layer was formed on the entire surface of the obtained substrate by a CVD method to form a protection film, and thus a patterned substrate for magnetic recording was obtained.

1. A polymer thin film, comprising:
a continuous phase primarily composed of polymers of a first monomer; and
cylindrical microdomains each of which is primarily composed of a polymer of a second monomer, the cylindrical microdomains being distributed in the continuous phase and oriented along a penetration direction through the film,
wherein the polymer thin film contains block copolymers which include at least respective first segments formed by polymerization of the first monomer and respective second segments formed by polymerization of the second monomer, and polymers compatible with the first segments,
and wherein the polymers are composed of the first monomer.

2. The polymer thin film of claim 1, wherein the polymer block copolymers and the polymers are arranged such as to satisfy the formula:
φmax−7≦φ≦max
where φ% represents a volume ratio of a sum of a volume of the first segments and a volume of the polymers in the polymer thin film, and φmax% represents a maximum φ% capable of forming the cylindrical microdomains.

3. The polymer thin film of claim 1, wherein a degree of polymerization of the polymers is less than a degree of polymerization of the first segments in the block copolymers.

4. The polymer thin film of claim 1, wherein a degree of polymerization of the second segments of the block copolymers is less than a degree of polymerization of the first segments.

5. The polymer thin film of claim 1, wherein the block copolymers are diblock copolymers each of which is formed such that an end of the first segment and an end of the second segment are bound to each other.

6. The polymer thin film of claim 1, wherein the block copolymers further include respective third segments formed by polymerization of a third monomer and an end of each of the third segments is bound with either an end of the first segment or an end of the second segment.

7. The polymer thin film of claim 1, wherein the first monomer is a styrene monomer and the second monomer is a methylmethacrylate monomer.

8. The polymer thin film of claim 1, wherein the first monomer is a methylmethacrylate monomer and the second monomer is a styrene monomer.

9. (canceled)

10. The polymer thin film of claim 1, wherein the polymer thin film is formed on a surface of a substrate.

11. The polymer thin film of claim 10, wherein the polymer thin film is formed in a recession provided on the surface of a the substrate.

12. A method of producing a patterned substrate, comprising:
coating a solution on a surface of a substrate, the solution containing block copolymers which include at least respective first segments formed by polymerization of a first monomer and respective second segments formed by polymerization of a second monomer, and polymers compatible with the first segments;
forming a coated film on the surface of the substrate by evaporating solvent from the solution; and
forming, by heating the surface of the substrate, a microphase separated structure in the coated film, the microphase separated structure being separated into a continuous phase primarily composed of the first segments and cylindrical microdomains each of which is primarily composed of the second segment, the cylindrical microdomains being distributed in the continuous phase and oriented along a penetration direction through the film.

13. The method of producing a patterned substrate of claim 12, further comprising:
selectively removing one of polymer phases being the continuous phase and a polymer phase of the cylindrical microdomains.

14. The method of producing a patterned substrate of claim 13, further comprising:
transferring a pattern of the microphase separated structure onto the surface of the substrate by processing the substrate through the other one of the polymer phases.

15. The method of producing a patterned substrate of claim 13, further comprising:
transferring a pattern of the microphase separated structure onto a surface of a transfer object by making the transfer object tightly contact with the other one of the polymer phases.

16. The method of producing a patterned substrate of claim 13, further comprising:
peeling off the other polymer phase from the surface of the substrate.

17. The method of producing a patterned substrate of claim 12, wherein the polymer block copolymers and the polymers are arranged such as to satisfy the formula:
φmax−7≦φ≦φmax
where φ% represents a volume ratio of a sum of a volume of the first segments and a volume of the polymers in the forming of the coated film, and φmax % represents a maximum φ% capable of forming the cylindrical microdomains.

18. The method of producing a patterned substrate of claim 12, wherein the polymers are composed of the first monomer.

19. The method of producing a patterned substrate of claim 13, wherein metal atoms are doped to one of the polymer phases.

20. A pattern carrier produced by using the method of producing a patterned substrate of claim 12.

21. A patterned medium for magnetic recording produced by using the method of producing a patterned substrate of claim 12.
